(19) United States
(12) Patent Application Publication
(10) Pub. No.: US 2026/0043689 A1
(43) Pub. Date: Feb. 12, 2026

(54) INSTANT-READ THERMOMETER PROVIDING FEEDBACK TO INDICATE A LOWEST DETECTED TEMPERATURE

(71) Applicant: Weber-Stephen Products LLC, Palatine, IL (US)

(72) Inventors: Nicholas Beyrer, San Francisco, CA (US); Gabriel Risk, San Francisco, CA (US); Dylan Mcgregor, San Francisco, CA (US)

(21) Appl. No.: 19/297,164

(22) Filed: Aug. 12, 2025

Related U.S. Application Data
(60) Provisional application No. 63/681,916, filed on Aug. 12, 2024.

(51) Int. Cl. G01K 1/024; G01K 1/02

(52) U.S. Cl. CPC G01K 1/024; G01K 1/026; G01K 2215/00

(57) ABSTRACT

The present disclosure describes an instant-read thermometer. The instant-read thermometer comprises a needle and a body configured to house circuitry. The needle may include one or more sensors configured to detect a temperature of food, a cooking liquid, ambient temperature, and the like. The housing may include circuitry, including a printed circuit board comprising one or more processors, memory, and/or a haptic feedback mechanism. The housing may also store one or more batteries. The circuitry may be configured to provide feedback (e.g., haptic, tactile, audible, or visual) to a user based on the temperature detected by the one or more sensors.

### CROSS-REFERENCE TO RELATED APPLICATIONS

This application claims the benefit of U.S. Provisional Application No. 63/681,916, filed Aug. 12, 2024, the entirety of which is hereby incorporated by reference for all purposes.

### FIELD OF THE INVENTION

Aspects of the disclosure generally relate to instant-read thermometers and, specifically, instant-read thermometers that provide feedback to indicate a lowest detected temperature.

### BACKGROUND OF THE INVENTION

While cooking, people will periodically check the internal temperature of food using an instant-read thermometer. Oftentimes, people will overshoot the center, or coolest, portion of the food. This may lead to inaccurate temperature measurements, which may cause the food to be undercooked.

### SUMMARY OF THE INVENTION

The following presents a simplified summary of various features described herein. This summary is not an extensive overview, and is not intended to identify key or critical elements or to delineate the scope of the claims. The following summary merely presents some concepts in a simplified form as an introductory prelude to the more detailed descriptions provided below. Corresponding apparatus, systems, and computer-readable media are also within the scope of the disclosure.

Aspects of the disclosure generally relate to an instant-read thermometer that provides feedback when the needle of the instant-read thermometer is at the center, or coolest, location of the food. Preferably, the feedback is haptic or tactile; however, the feedback may also be audible and/or visual. Accordingly, aspects of the present disclosure describe an instant-read thermometer with one or more feedback mechanisms and methods for measuring an internal cooking temperature of food using the instant-read thermometer with the one or more feedback mechanisms.

The instant-read thermometer of the present disclosure may include a hollow needle and a body. The hollow needle may be configured to be inserted in a food to measure the food's internal temperature. Accordingly, the hollow needle may comprise one or more sensors located throughout the hollow needle. The one or more sensors may be configured to detect one or more temperatures of a food. The body may house circuitry, such as a processor, a haptic feedback mechanism, a speaker, and/or a display. The body may also house a power supply, such as one or more batteries or a capacitor.

In operation, the processor of the instant-read thermometer may determine an internal temperature of the food, for example, based on one or more temperatures detected by the one or more sensors. In this regard, the one or more temperatures may comprise a range of temperatures detected as the needle of the instant-read thermometer is inserted into the food. A high temperature may be detected near the periphery of the food, while a cooler temperature may be detected in the center of the food. It will be appreciated that the temperatures will begin increasing as the needle passes the center of the food and continues to the opposite, exterior edge. In response to receiving the temperatures, the processor may determine the lowest temperature. Upon determining the lowest temperature, the processor may send a signal to the haptic, or tactile, feedback mechanism. In response to receiving the signal from the processor, the haptic, or tactile, feedback mechanism may generate a perceptible vibration to indicate that the needle is located in the center, or coolest portion, of the food. The processor may also cause an audible and/or a visual alert to be provided, for example, based on or in response to determining the lowest temperature. By providing feedback, the user may stop inserting the needle into the food, thereby obtaining a more accurate measurement of the food as it cooks.

These features, along with many others, are discussed in greater detail below.

### BRIEF DESCRIPTION OF DRAWINGS

The present disclosure is described by way of example and not limited in the accompanying figures in which like reference numerals indicate similar elements and in which:

FIG. 1 shows an example of an instant-read thermometer in accordance with one or more aspects of the disclosure;

FIG. 2 shows an example of another instant-read thermometer in accordance with one or more aspects of the disclosure;

FIG. 3 shows an example of the circuitry of an instant-read thermometer in accordance with one or more aspects of the disclosure;

FIG. 4 shows an example of a process for measuring internal cooking temperature using the instant-read thermometer of the present disclosure;

FIGS. 5A-5D show an example of measuring internal cooking temperature in accordance with one or more aspects of the disclosure;

FIG. 6 shows an example of an environment where a wireless temperature probe may be used;

FIG. 7 shows an example of a display for monitoring internal cooking temperatures in accordance with one or more aspects of the disclosure;

FIG. 8 shows an example of monitoring internal cooking temperatures using a mobile device in accordance with one or more aspects of the disclosure; and

FIG. 9 shows an example of monitoring internal cooking temperatures using a wearable device in accordance with one or more aspects of the disclosure.

### DETAILED DESCRIPTION OF THE INVENTION

In the following description, reference is made to the accompanying drawings, which form a part hereof, and in which are shown various examples of features of the disclosure and/or of how the disclosure may be practiced. It is to be understood that other features may be utilized and structural and functional modifications may be made without departing from the scope of the present disclosure. The disclosure may be practiced or carried out in various ways. In addition, it is to be understood that the phraseology and terminology used herein are for the purpose of description and should not be regarded as limiting. Rather, the phrases and terms used herein are to be given their broadest interpretation and meaning consistent with the disclosures and/or descriptions below.

By way of introduction, features discussed herein may relate to an instant-read thermometer providing feedback when the needle of the instant-read thermometer is at the center, or coolest, location of the food.

As described in greater detail below, the instant-read thermometer of the present disclosure may include a hollow needle and a body. The hollow needle comprises one or more sensors that are configured to detect an internal cooking temperature of food when the needle is inserted in the food. The one or more sensors may provide one or more indications of the internal cooking temperature to a body of the instant-read thermometer, which includes a processor, memory, a haptic feedback mechanism, a speaker, and/or a display. The processor may determine an internal temperature of the food, for example, based on one or more temperatures detected by the one or more sensors. The processor may store the one or more temperatures in a memory. Based on the one or more temperatures, the processor may determine the lowest temperature, for example, by tracking the temperatures on a graph or detecting a temperature increase after the temperatures have been decreasing for a predetermined amount of time. Upon determining the lowest temperature, the processor may provide feedback to the user to indicate the lowest temperature has been detected. The feedback may comprise one or more of audible, visual, and/or tactile feedback. In some instances, the processor may send a signal to the haptic, or tactile, feedback mechanism, which then generates a perceptible vibration to indicate that the needle is located in the center, or coolest, portion of the food. The processor may also cause the one or more temperatures to be displayed. By providing feedback at the coolest location of the food, the user may stop inserting the needle into the food, thereby obtaining a more accurate measurement of the food as it cooks.

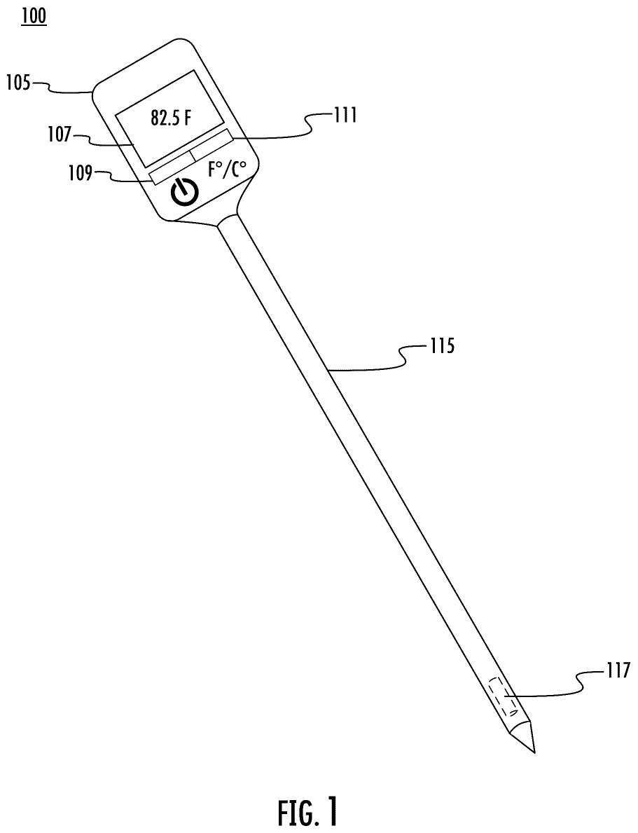

FIG. 1 shows an example of an instant-read thermometer 100 in accordance with one or more aspects of the disclosure. Instant-read thermometer 100 may comprise body 105 and needle 115. Body 105 may comprise display 107, a power button 109, and/or a temperature button 111. Needle 115 may comprise a sensor 117.

Body 105 may be made from any suitable material, such as plastic. Body 105 may be configured to store circuitry and other components, described in greater detail below. In particular, body 105 may comprise display 107. Display 107 may be configured to display a temperature associated with a location of the tip of needle 115 and/or sensor 117. Additionally or alternatively, display 107 may be configured to display an internal temperature of a food, for example, when instant-read thermometer 100 is inserted into the food. In some examples, display 107 may provide an indication that tip of needle 115 is located in the center, or coolest, location of the food. Additionally or alternatively, display 107 may provide directional guidance toward the center, or coolest, location of the food. For instance, display 107 may cause one or more arrows to be displayed to show the direction in which needle 115 should be moved to reach the center, or coolest, location of the food. Display 107 may comprise a liquid crystal display (LCD) display technology, a light emitting diode (LED) display technology, vacuum florescent display technology, and/or any equivalent thereof. Power button 109 may be configured to power instant-read thermometer 100 on and off, for example, in response to being pressed. Temperature button 111 may cause the display to toggle between displaying temperatures in Fahrenheit and Celsius.

Needle 115 may be a hollow cylindrical body with a closed distal end and an open proximal end. The closed distal end may be conical in shape. The closed distal end may be configured to be inserted into a food while cooking. Needle 115 may be made of any suitable material. Preferably, needle 115 is made from stainless steel (e.g., SS304) due to stainless steel's high resistance to corrosion and malleability for ease of fabrication. Needle 115 may have an inner diameter between approximately .5 millimeters (mm) and 6 mm, and preferably approximately 1 mm. The outer diameter of needle 110 may be between 1 mm and 6 mm, and preferably approximately 2.75 mm.

Sensor 117 may be communicatively coupled to, or in contact with, an interior wall of needle 115. In this regard, sensor 117 may be configured to measure (e.g., monitor, detect) an internal temperature of a food. Sensor 117 may measure the internal temperature of the food periodically, for example, as needle 115 is inserted into the food. Sensor 117 may be a thermocouple configured to measure temperatures up to 300° C. (572° F.). Additionally or alternatively, sensor 117 may be a thermistor. Preferably, sensor 117 may comprise at least one of a negative temperature coefficient (NTC) thermistor, a positive temperature coefficient (PTC), thermistor, or a resistance temperature detector (RTD).

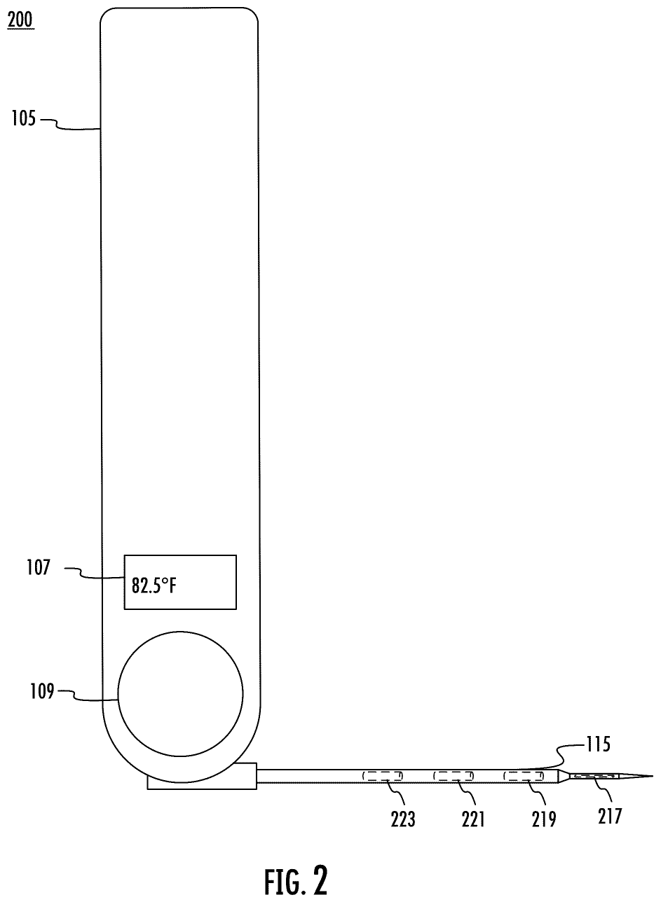

FIG. 2 shows an example of another instant-read thermometer 200 in accordance with one or more aspects of the disclosure. Like instant-read thermometer 100, instant-read thermometer may comprise body 105 and needle 115. Body 105 may comprise display 107 and a power button 109. Needle 115 may comprise a plurality of sensors (e.g., first sensor 217, second sensor 219, third sensor 221, fourth sensor 223, etc.).

First sensor 217 may comprise a thermocouple configured to measure (e.g., monitor, detect) an internal temperature of a food. First sensor 217 may be located in the closed distal end of needle 115. First sensor 217 may be small enough to fit in the tip of needle 115. In this regard, needle 115 may be configured to pierce food and/or come in contact with bones, which may expose first sensor 217 to higher temperatures than typically encountered when cooking food. Because of this, first sensor 217 may be configured to measure temperatures up to 300° C. (572° F.). In operation, first sensor 217 may measure temperatures up to 100° C. (212° F.). Alternatively, first sensor 217 may be a thermistor, such as an NTC thermistor, a PTC thermistor, or a RTD.

Second sensor 219, third sensor 221, and/or fourth sensor 223 may be any suitable sensor for measuring the internal temperature of the food. The one or more temperature sensors (e.g., second sensor 219, third sensor 221, and/or fourth sensor 223) may be thermistors, such as NTC thermistors, PTC thermistors, or RTDs. The one or more temperature sensors (e.g., second sensor 219, third sensor 221, and/or fourth sensor 223) may be located throughout needle 115. In some instances, the one or more temperature sensors (e.g., second sensor 219, third sensor 221, and/or fourth sensor 223) may be distributed at equal distances throughout needle 115. Each of the one or more temperature sensors (e.g., second sensor 219, third sensor 221, and/or fourth sensor 223) may be configured to measure temperatures up to 150° C. (302° F.). By using a plurality of temperature sensors, a more accurate reading of the internal temperature of the food may be obtained. For example, first sensor 217 may not be located in the center of the food. Alternatively, first sensor 217 may be proximately located near bone or other tissue. In both scenarios, first sensor 217 may provide an inaccurate reading of the temperature of the food. The plurality of sensors (e.g., second sensor 219, third sensor 221, and/or fourth sensor 223) described herein may obtain multiple measurements, at different locations throughout the food, thereby ensuring an accurate and even internal cooking temperature is obtained.

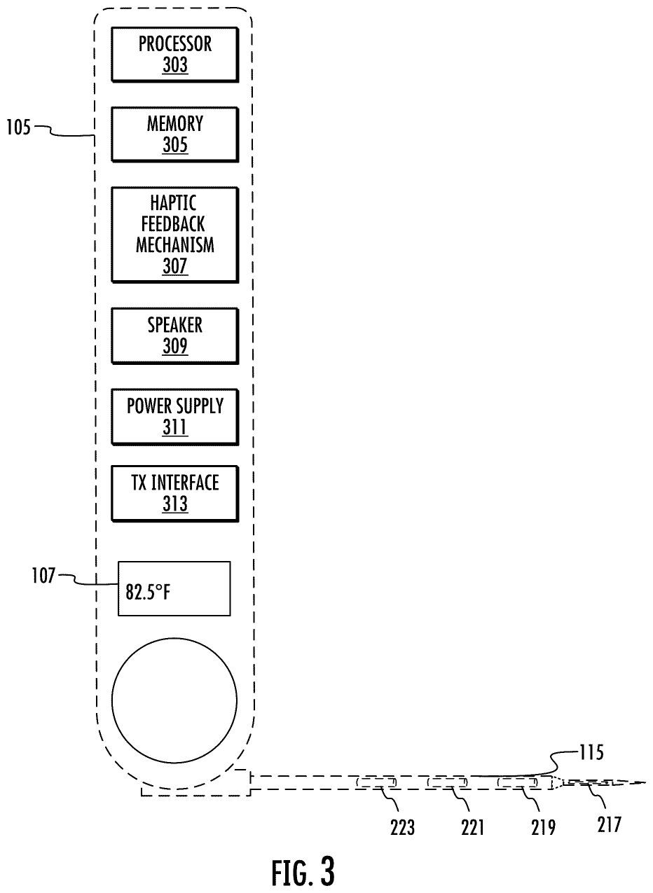

FIG. 3 shows an example of the circuitry of an instant-read thermometer in accordance with one or more aspects of the disclosure. Housing 105 may contain circuitry and a power supply 311. The circuitry may comprise a printed circuit board comprising processor 303, memory 305, haptic feedback mechanism 307, speaker 309, and/or a transmission interface 313. The printed circuit board may be made from any suitable dielectric material, including, for example, FR4. The printed circuit board may be configured to operate at a wide range of temperatures, including those achieved by home grills and ovens. In some instances, an insulating material may be placed between the printed circuit board and housing 105. The insulating material may be a foam, a gel, or any other suitable material capable of providing insulation between the housing 105 and the printed circuit board.

Processor 303 may be any suitable processor, such as a single-core or multi-core processor, or may include multiple CPUs. In some examples, processor 303 may include a low-power processor and/or microcontroller, such as an Advanced RISC Machine (ARM) processor and/or any suitable field programmable array (FPGA), application specific integrated circuit (ASIC), or system on a chip (SOC). Processor 303, and associated components described herein, may execute a series of computer-readable instructions (e.g., instructions stored in memory 305) to perform some or all of the processes described herein. In operation, processor 303 may receive one or more signals from a temperature sensor (e.g., sensor 117, first sensor 217, second sensor 219, third sensor 221, fourth sensor 223, etc.). The one or more signals may be associated with an internal temperature of a food. Processor 303 may cause the internal temperature of the food to be displayed via display 107. Additionally or alternatively, processor 303 may monitor a range of temperatures, for example, as needle 115 is inserted into the food. Processor 303 may determine a lowest temperature of the range of temperatures. In response to determining the lowest temperature, processor 303 may send one or more signals to haptic feedback mechanism 307, which may cause haptic feedback mechanism 307 to generate or produce one or more vibrations that are capable of being felt, or detected, by a user of the instant-read thermometer.

Memory 305 may be any suitable memory capable of storing instructions to be executed by processor 303. In this regard, memory 305 may comprise volatile and nonvolatile, non-removable media implemented in any method or technology for storage of information such as computer-readable instructions, data structures, program modules, or other data. Memory 305 may comprise one or more physical persistent memory devices and/or one or more non-persistent memory devices. Memory 305 may comprise random access memory (RAM), read only memory (ROM), electronically erasable programmable read only memory (EEPROM), flash memory or other memory technology or any other medium that may be used to store the desired information and that may be accessed by processor 303. In some instances, memory 305 may store, or cache, the range of temperatures sent to processor 303 by the one or more sensors (e.g., sensor 117, first sensor 217, second sensor 219, third sensor 221, fourth sensor 223, etc.).

Haptic feedback mechanism 307 may be any suitable mechanism configured to generate or produce a tactile or haptic response detectable by a user of the instant-read thermometer of the present disclosure. For the purposes of this disclosure, “haptic” and “tactile” may be used interchangeably. The tactile or haptic response may be generated or produced, for example, in response to detecting increasing temperatures after the temperatures have been decreasing for a predetermined amount of time. Additionally or alternatively, the tactile or haptic response may be generated or produced, for example, in response to detecting a lowest temperature, of a range of temperatures. In some instances, the range of temperatures may be tracked on a graph. In this regard, processor 303 may send a signal to haptic feedback mechanism 307 in response to determining the lowest temperature. In response to receiving the signal, haptic feedback mechanism 307 may generate or produce the haptic or tactile feedback. In some examples, haptic feedback mechanism 307 may comprise an actuator, such as an eccentric rotating mass (ERM) actuator, a linear resonant actuator (LRA), a voice coils actuator (VCA/VCM), a piezoelectric actuator (PA), or the like.

Speaker 309 may comprise any suitable speaker. Speaker 309 may be configured to produce (e.g., emit) one or more audible alerts. The audible alerts may be configured to convey one or more messages to a user of the instant-read thermometer. For example, a first audible alert may indicate that the instant-read thermometer is powered on. A second audible alert may indicate that the tip of the instant-read thermometer is in the coldest part of the food. The second audible alert may be used in conjunction with the haptic, or tactile, feedback produced by haptic feedback mechanism 307. A third audible alert may indicate when the instant-read thermometer is being powered off. It will be appreciated that these audible alerts are merely illustrative and other audible alerts may be emitted by speaker 309.

Transmission interface 313 may comprise one or more antennas, transceivers, digital signal processors, and/or additional circuitry and software, protocol stack, and/or network stack for communicating via any network, wired or wireless, using any protocol as described herein. Transmission interface 313 may be configured to send and/or receive electronic communications using a short-range wireless communication protocol, such as Bluetooth, Zigbee, Z-Wave, ANT, LoRa, or any equivalent thereof. Additionally or alternatively, transmission interface 313 may be configured to send and/or receive electronic communications and/or signals using wireless communication protocols, such as IEEE 802.11, WiFi, GSM, CDMA, and the like. According to some examples, transmission interface 313 may be configured to send signals, not receive them. In this regard, transmission interface 313 may be configured to send one or more internal cooking temperatures to a device, such as a mobile device, a smart phone, a table, a grill interface, and the like.

Power supply 311 may be configured to provide power to the instant-read thermometers described herein. Power supply 311 may comprise a rechargeable battery, a capacitor, a supercapacitor, or any equivalent thereof. Additionally or alternatively, power supply 311 may comprise one or more batteries (e.g., alkaline batteries).

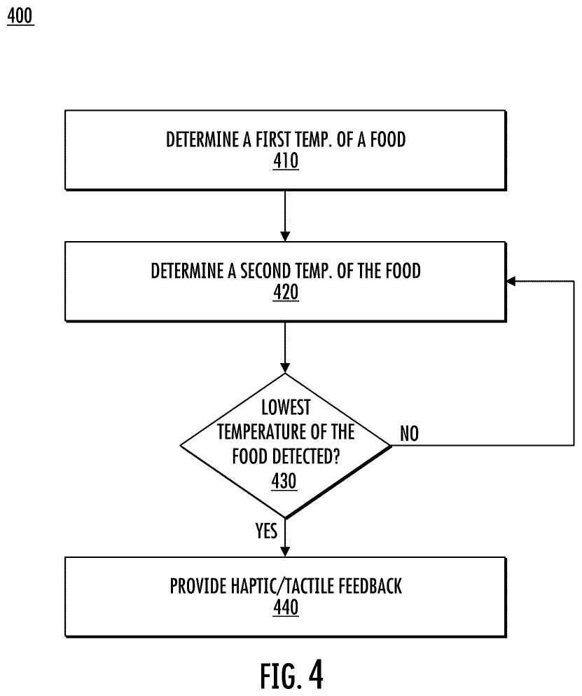

As discussed above, an instant-read thermometer may be used to measure an internal temperature of food as the food cooks. FIG. 4 shows an example of a process 400 for measuring the internal temperature in accordance with one or more aspects of the disclosure.

In step 410, an instant-read thermometer may determine a first temperature of a food. The first temperature of the food may be obtained after the instant-read thermometer has been inserted into the food. Prior to being inserted, the instant-read thermometer may measure an ambient temperature. The ambient temperature may be ignored for the purpose of indicating the coolest temperature of the food. The instant-read thermometer may disregard the ambient temperature, for example, based on the temperature range detected by the instant-read thermometer. That is, the instant-read thermometer may be configured to not generate haptic, or tactile, feedback for temperatures between 60°-90° F. (15°-32° C.). Alternatively, the instant-read thermometer may be configured to not generate haptic, or tactile, feedback for temperatures below a threshold (e.g., 100° F. (37° C.)). In some instances, the instant-read thermometer may disregard the ambient temperature, for example, based on determining that the detected temperatures have not been decreasing or the detected temperatures have remained constant for a predetermined amount of time. In some instances, the instant-read thermometer may begin monitoring for the lowest temperature in response to a button push. For example, when the instant-read thermometer is powered on, the instant-read thermometer may display temperature in real-time, or near real-time. When a button (e.g., button 109) is pressed (e.g., short pressed, double-clicked, pressed again after being powered on, etc.), the display may indicate that a user should start inserting the instant-read thermometer into the food. The device may then start processing the data (e.g., temperatures). Afterwards the instant-read thermometer may time out, for example, because it could not find the center and/or displays the lowest detected temperature. The first temperature may be associated with a tip of the needle of the instant-read thermometer. In this regard, the first temperature may be associated with a first location of the tip of the needle. Additionally or alternatively, the first temperature may be associated with a location of one or more sensors located within the needle of the instant-read thermometer. In some examples, the instant-read thermometer may store the first temperature in a memory, such as memory 305 discussed above. In further examples, the instant-read thermometer may cause the first temperature to be displayed via a display, such as display 107.

As the needle of the instant-read thermometer continues to be inserted into the food, the instant-read thermometer may detect a second temperature of the food, in step 420. The second temperature may be associated with a second location of the food. The instant-read thermometer may also store the second temperature in memory. As will be discussed in greater detail below, storing the temperatures in memory may allow the instant-read thermometer to track the temperature of the food to determine the lowest (e.g., coolest) temperature. As noted above, the instant-read thermometer may cause the second temperature to be displayed via a display of the instant-read thermometer.

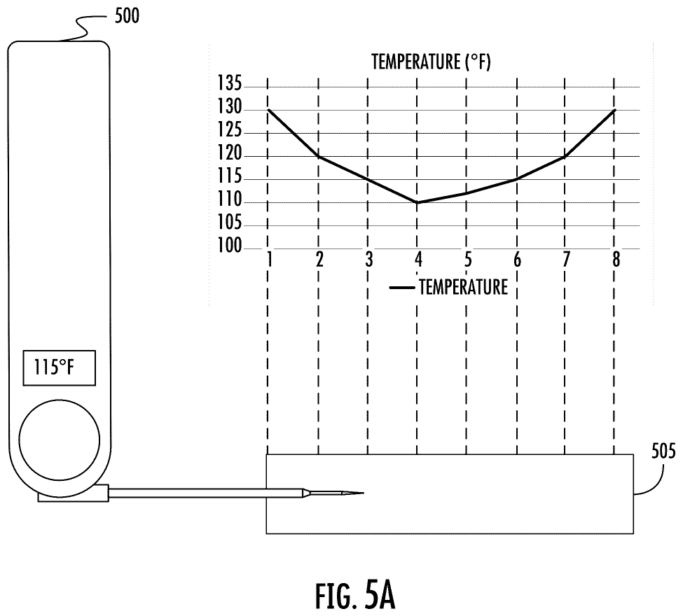

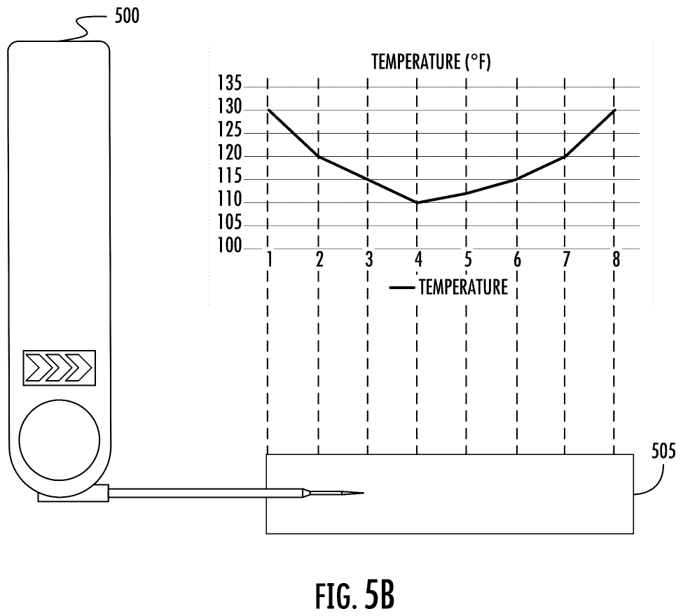

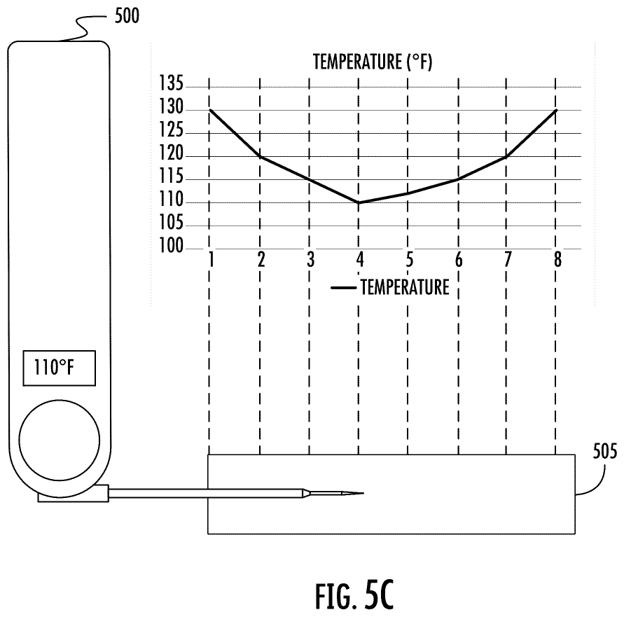

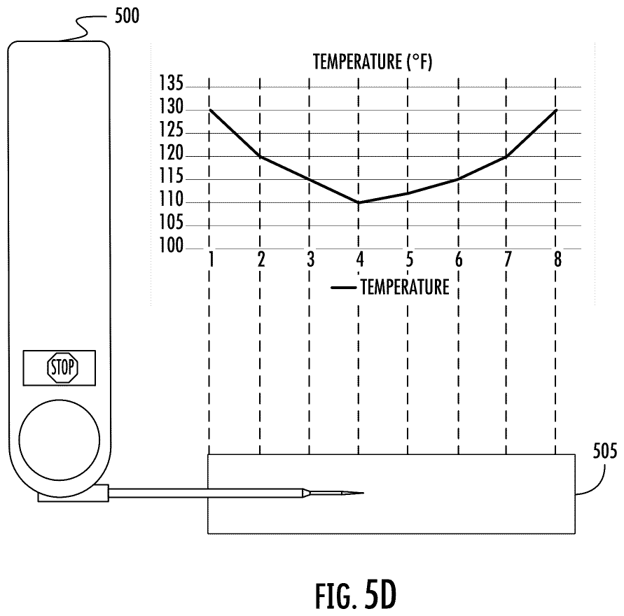

In step 430, the instant-read thermometer may determine whether the lowest temperature of the food has been detected. As noted above, the instant-read thermometer may determine the lowest temperature based on tracking a range of temperatures as the needle of the instant-read thermometer is inserted into the food. In this regard, the instant-read thermometer may determine the lowest temperature by tracking the range of temperatures on a graph, similar to the one shown in FIG. 5 and discussed below. Additionally or alternatively, the instant-read thermometer may determine the lowest temperature, for example, based on the range of temperatures beginning to increase after decreasing for a predetermined amount of time. If the lowest temperature has not been detected, process 400 may return to step 420, with the instant-read thermometer continuing to obtain an internal temperature of the food as the needle continues to be inserted deeper into the food. However, if the lowest temperature is detected process 400 may proceed to step 440.

In step 440, the instant-read thermometer may provide haptic, or tactile, feedback to the user. The haptic, or tactile, feedback may signal to the user that the tip of the instant-read thermometer is at the coolest (center) of the food. In this regard, the processor may determine that the temperature detected by one or more sensors of the instant-read thermometer is the coolest (lowest) temperature. Accordingly, the processor may send a signal to the haptic feedback mechanism. In response to receiving the signal, the haptic feedback mechanism may generate a perceptible vibration to indicate that the needle is located in the center, or coolest portion, of the food. The perceptible vibration may be generated using an actuator, such as an eccentric rotating mass (ERM) actuator, a linear resonant actuator (LRA), a voice coils actuator (VCA/VCM), a piezoelectric actuator (PA), or the like. In some examples, the instant-read thermometer may provide an audible notification, in addition to the haptic, or tactile, feedback.

FIGS. 5A-5D show an example of measuring internal cooking temperature in accordance with one or more aspects of the disclosure. As shown in FIGS. 5A-5D, instant-read thermometer 500 may be inserted into food 505. As instant-read thermometer 500 is inserted into food 505, instant-read thermometer 500 may measure the temperature of food 505 at various locations. In this regard, instant-read thermometer 500 may continuously monitor temperatures as the needle of instant-read thermometer 500 is inserted into food 505. Food 505 may have different temperatures associated with different locations. For example, at an exterior, insertion point (first location), food 505 may have a first temperature of 130° F. (54° C.). As noted above, instant-read thermometer 500 may store the first temperature in memory. At a second location, food 505 may have a second temperature of 120° F. (48° C.). As shown in FIGS. 5A and 5B, Food 505 may have a third temperature of 115 F (46° C.) at a third location. FIG. 5A shows instant-read thermometer 500 displaying the third temperature. FIG. 5B shows instant-read thermometer 500 displaying an indication of which direction instant-read thermometer 500 should be moved to obtain the lowest temperature. In this regard, food 505 may have a fourth temperature 110° F. (43° C.) at a fourth location, a fifth temperature 112° F. (44° C.) at fifth location, a sixth temperature 115° F. (46° C.) at a sixth location, a seventh temperature 120° F. (48° C.) at a seventh location, and an eighth temperature 130° F. (54° C.) at an eighth location. In some instances, instant-read thermometer 500 may plot each temperature on a graph. Using the graph, instant-read thermometer 500 may detect when temperatures begin increasing after steadily decreasing. As shown in FIG. 5D, instant-read thermometer 500 may generate feedback when the needle of instant-read thermometer reaches the fifth location. As noted above, the feedback may comprise one or more of haptic, tactile, audible, and/or visual feedback. In some instances, instant-read thermometer 500 may display the temperature associated with the fifth location (e.g., 112° F. (44° C.)). Alternatively, and as shown in FIG. 5D, instant-read thermometer 500 may display an indication to stop moving (e.g., inserting) the needle into the food. In some instances, instant-read thermometer 500 may display the lowest temperature (i.e., the fourth temperature, before the temperatures began increasing again), as shown in FIG. 5C. In response to the feedback, the user may stop inserting the needle into the food, thereby obtaining a more accurate measurement of the food as it cooks.

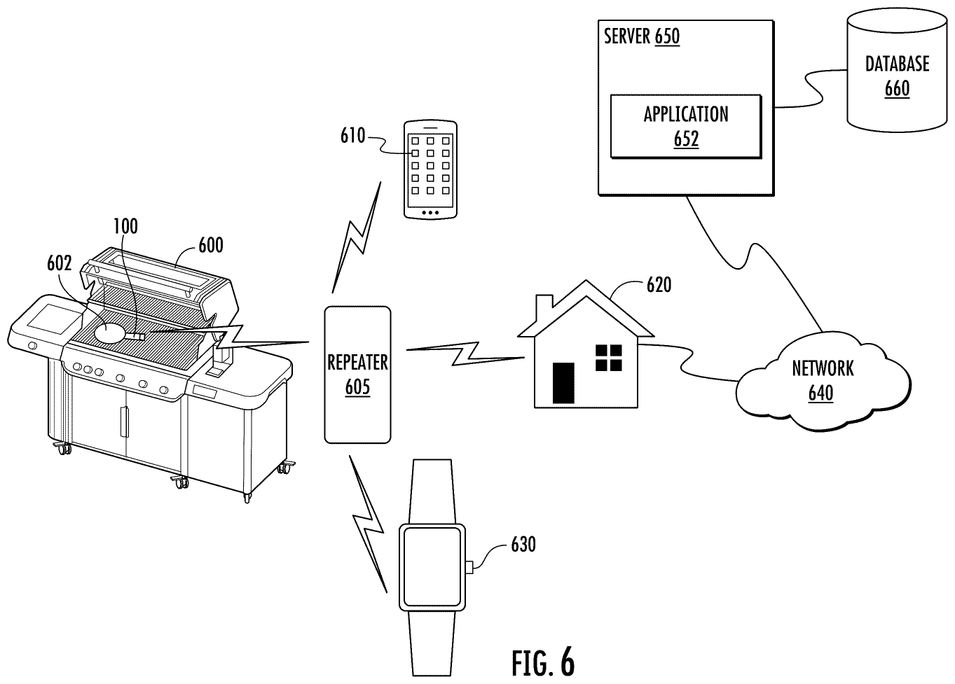

FIG. 6 shows an example of an environment where a wireless temperature probe 100 may be used. The environment includes grill 600, user device 610, home network 620, and wearable device 630. Home network 620 may be connected to server 650 via network 640. Server 650 may include database 660.

As shown in FIG. 6, food 602 may be cooking on grill 600. Wireless temperature probe 100 may be inserted food 602, as it cooks, to monitor the internal temperature of food 602. While a grill is shown in FIG. 6, it will be appreciated that any suitable cooking appliance, such as a smoker, an oven, etc., may be used in its place. Using the techniques described above, wireless temperature probe 100 may transmit (e.g., send) the internal temperature of food 602 to user device 610, wearable device 630, and/or server 650 via home network 620 and/or network 640. In some instances, the internal temperature of food 602 may be sent to the devices via repeater 605.

Repeater 605 may be a range extender for wireless temperature probe 100. Additionally or alternatively, repeater 605 may be used to charge wireless temperature probe 100 when it is not being used. Repeater 605 may comprise a first interface to receive wireless communications from wireless temperature probe 100. Repeater 605 may comprise a second interface to send wireless communications to one or more devices (e.g., user device 610, wearable device 630, and/or server 650). In some instances, the first interface and the second interface may be the same interface. In other examples, the first interface and the second interface are different interfaces. The first interface may be configured to receive electronic communications using a short-range wireless communication protocol, such as Bluetooth®, Zigbee, Z-Wave, ANT, LoRa, or any equivalent thereof. The second interface may be configured to send electronic communications and/or signals using wireless communication protocols, such as IEEE 802.11, WiFi, GSM, CDMA, and the like.

User device 610 may be a mobile device, such as a cellular phone, a mobile phone, a smart phone, a tablet, a laptop, or the like. Alternatively, user device 610 may be any suitable internet-enabled device, such as a smart speaker, smart television, or the like. In further examples, user device 610 may be a smart grilling hub, such as the Weber Connect® Smart Grilling Hub. User device 610 may have one or more applications stored thereon. A first application, of the one or more applications, may be configured to receive and display the internal temperature of food 602. In some instances, the first application may be configured to generate an alert when food 602 reaches a target temperature. The alert may be an audible alert, a visual alert, a tactile alert, or any combination thereof.

Wearable device 630 may be a device worn and/or attached to a user. In this regard, wearable device 630 may be a smart watch, a fitness tracker, augmented reality (AR) goggles/glasses, etc. Wearable device 630 may have one or more applications or applets that are configured to receive and display the internal temperature of food 602. The one or more applications may be configured to generate an alert when food 602 reaches a target temperature. The alert may be an audible alert, a visual alert, a tactile alert, or any combination thereof.

Server 650 may be any server capable of executing application 652. As noted above, server 650 may be communicatively coupled to database 660. Server 650 may be a stand-alone server, a corporate server, or a server located in a server farm or cloud-computer environment. According to some examples, server 650 may be a virtual server hosted on hardware capable of supporting a plurality of virtual servers.

Application 652 may be server-based software configured to receive the internal temperature of food 602. Application 652 may be configured to send the internal temperature of food 602 to user device 610 and/or wearable device 630. Application 652 may send the internal temperature of food 602 via one or more electronic communications, such as a text message, a push notification, etc. In some instances, application 652 may send (e.g., transmit) one or more notifications to user device 610 and/or wearable device 630. The one or more notifications may prompt the user to measure an internal temperature of food 602 using wireless temperature probe 100. In this regard, application 652 may store one or more temperatures at different time intervals. Application 652 may predict (e.g., determine, calculate) an end time, for example, based on the one or more temperatures at different time intervals. Application 652 may cause the predicted end time to be displayed on user device 610 and/or wearable device 630.

Database 660 may be configured to store information on behalf of application 652. The information may include, but is not limited to, personal information and/or account information for a user. Database 660 may include, but is not limited to, relational databases, hierarchical databases, distributed databases, in-memory databases, flat file databases, XML databases, NoSQL databases, graph databases, and/or a combination thereof.

Network 640 may include any type of network, including the Internet, a local area network (LAN), a wide area network (WAN), a wireless telecommunications network, and/or any other communication network or combination thereof. It will be appreciated that the network connections shown are illustrative and any means of establishing a communications link between the computers may be used. The existence of any of various network protocols such as TCP/IP, Ethernet, FTP, HTTP and the like, and of various wireless communication technologies such as GSM, CDMA, WiFi, and LTE, is presumed, and the various computing devices described herein may be configured to communicate using any of these network protocols or technologies. The data transferred to and from various computing devices may include secure and sensitive data, such as confidential documents, customer personally identifiable information, and account data. Therefore, it may be desirable to protect transmissions of such data using secure network protocols and encryption, and/or to protect the integrity of the data when stored on the various computing devices. For example, a file-based integration scheme or a service-based integration scheme may be utilized for transmitting data between the various computing devices. Data may be transmitted using various network communication protocols. Secure data transmission protocols and/or encryption may be used in file transfers to protect the integrity of the data, for example, File Transfer Protocol (FTP), Secure File Transfer Protocol (SFTP), and/or Pretty Good Privacy (PGP) encryption. In many embodiments, one or more web services may be implemented within the various computing devices. Web services may be accessed by authorized external devices and cardholders to support input, extraction, and manipulation of data between the various computing devices. Web services built to support a personalized display system may be cross-domain and/or cross-platform and may be built for enterprise use. Data may be transmitted using the Secure Sockets Layer (SSL) or Transport Layer Security (TLS) protocol to provide secure connections between the computing devices. Web services may be implemented using the WS-Security standard, providing for secure SOAP messages using XML encryption. Specialized hardware may be used to provide secure web services. For example, secure network appliances may include built-in features such as hardware-accelerated SSL and HTTPS, WS-Security, and/or firewalls.

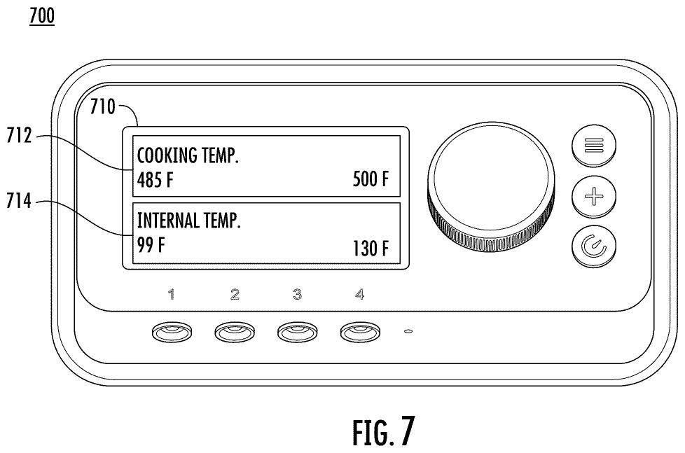

FIG. 7 shows an example of a display for monitoring internal cooking temperatures in accordance with one or more aspects of the disclosure. Interface 700 may be part of a cooking appliance, such as a grill, an oven, a smoker, or the like. Alternatively, interface 700 may be associated with a device configured to monitor cooking temperatures, similar to the Weber Connect® Smart Grilling Hub. Interface 700 may comprise a display 710. Display 710 may comprise a liquid crystal display (LCD) display technology, a light emitting diode (LED) display technology, vacuum florescent display technology, and/or the like. Display 710 may be configured to first field 712 configured to display the ambient temperature and/or a second field 714 configured to display the internal temperature of food. First field 712 may present both the actual temperature (e.g., 485° F.) and the target temperature (e.g., 500° F.). Similarly, second field 714 may present the actual temperature of the food (e.g., 99° F.) and the target temperature of the food (e.g., 130° F.).

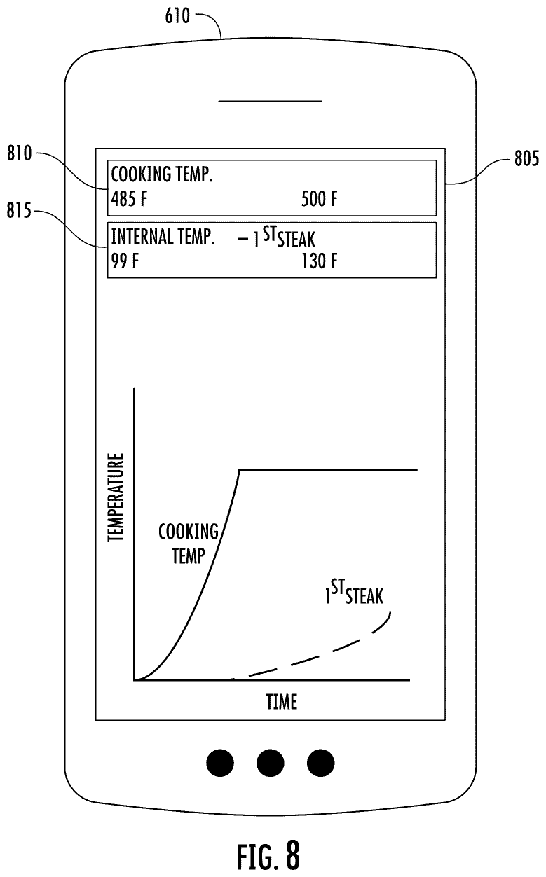

FIG. 8 shows an example of monitoring internal cooking temperatures using user device 610 in accordance with one or more aspects of the disclosure. User device 610 may comprise a first interface 805. First interface 805 may be associated with a mobile application configured to monitor the ambient temperature of a cooking chamber, the internal temperature of food, or both. First interface 805 may comprise a first field 810 configured to display an ambient temperature of the cooking chamber and a second field 815 configured to display a first internal temperature of a first food (e.g., 1st steak). First field 810 may display both the actual temperature (e.g., 485° F.) and the target temperature (e.g., 500° F.), which may be received from the cooking appliance. Second field 815 may display the actual temperature of a first food (e.g., 99° F.), which may be received from wireless temperature probe 100. Second field 815 may also display a target temperature of the first food (e.g., 130° F. for a steak).

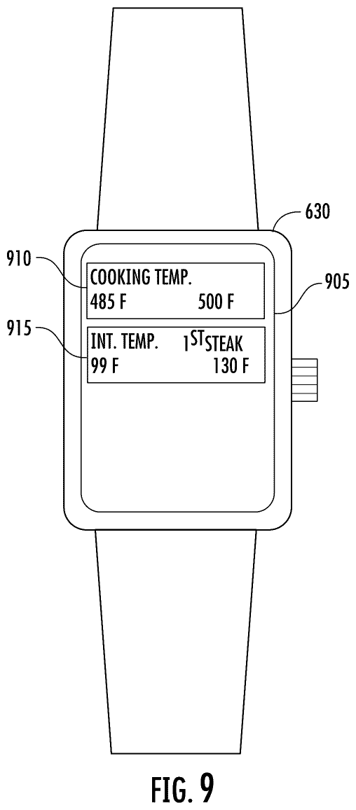

FIG. 9 shows an example of monitoring internal cooking temperatures using a wearable device 630 in accordance with one or more aspects of the disclosure. Wearable device 630 may comprise a first interface 905. First interface 905 may be associated with the mobile application executing on user device 610. Additionally or alternatively, first interface 905 may be associated with a second mobile application executing on the wearable device. The second mobile application may be configured to monitor the internal temperature of food. Similar to the previously described interfaces, first interface 905 may comprise a first field 910 configured to display an ambient temperature of the cooking chamber and a second field 915 configured to display a first internal temperature of a first food. First field 910 may display both the actual temperature (e.g., 485° F.) and the target temperature (e.g., 500° F.). Second field 915 may present the actual temperature of a first food (e.g., 99° F.) and/or the target temperature of the first food (e.g., 130° F.).

One or more features discussed herein may be embodied in computer-usable or readable data and/or computer-executable instructions, such as in one or more program modules, executed by one or more computers or other devices as described herein. Program modules may comprise routines, programs, objects, components, data structures, and the like, that perform particular tasks or implement particular abstract data types when executed by a processor in a computer or other device. The modules may be written in a source code programming language that is subsequently compiled for execution, or may be written in a scripting language such as (but not limited to) Python, Perl, or any equivalent thereof. The computer executable instructions may be stored on a computer-readable medium such as a hard disk, optical disk, removable storage media, solid-state memory, RAM, and the like. The functionality of the program modules may be combined or distributed as desired. In addition, the functionality may be embodied in whole or in part in firmware or hardware equivalents such as integrated circuits, field programmable gate arrays (FPGA), and the like. Particular data structures may be used to more effectively implement one or more features discussed herein, and such data structures are contemplated within the scope of computer executable instructions and computer-usable data described herein. Various features described herein may be embodied as a method, a computing device, a system, and/or a computer program product.

Although the present disclosure has been described in terms of various examples, many additional modifications and variations would be apparent to those skilled in the art. In particular, any of the various processes described above may be performed in alternative sequences and/or in parallel (on different computing devices) in order to achieve similar results in a manner that is more appropriate to the requirements of a specific application. It is therefore to be understood that the present disclosure may be practiced otherwise than specifically described without departing from the scope and spirit of the present disclosure. Although examples are described above, features and/or steps of those examples may be combined, divided, omitted, rearranged, revised, and/or augmented in any desired manner. Thus, the present disclosure should be considered in all respects as illustrative and not restrictive. Accordingly, the scope of the disclosure should be determined not by the examples, but by the appended claims and their equivalents.

1. An instant-read thermometer comprising:
a hollow needle;
one or more sensors located throughout the hollow needle, wherein the one or more sensors are configured to monitor one or more temperatures of a food;
a processor configured to determine an internal temperature of the food based on the one or more temperatures detected by the one or more sensors, wherein the one or more temperatures comprise a range of temperatures; and
a haptic feedback mechanism configured to provide haptic feedback when the one or more sensors are located in a lowest temperature of the range of temperatures.

2. The instant-read thermometer of claim 1, wherein the one or more sensors comprise at least one of:
a negative temperature coefficient (NTC) thermistor;
a positive temperature coefficient (PTC) thermistor;
a resistance temperature detector (RTD); or
a thermocouple.

3. The instant-read thermometer of claim 1, wherein the haptic feedback mechanism comprises an actuator.

4. The instant-read thermometer of claim 3, wherein the actuator comprises at least one of:
an eccentric rotating mass (ERM) actuator;
a linear resonant actuator (LRA);
a voice coils actuator (VCA); or
a piezoelectric actuator (PA).

5. The instant-read thermometer of claim 1, further comprising:
a display configured to display a temperature of the food associated with a location of the one or more sensors.

6. The instant-read thermometer of claim 1, wherein the processor is configured to determine the lowest temperature by tracking the range of temperatures on a graph.

7. The instant-read thermometer of claim 1, wherein the processor is configured to determine the lowest temperature based on the range of temperatures beginning to increase after decreasing for a predetermined amount of time.

8. The instant-read thermometer of claim 1, wherein an inner diameter of the hollow needle is between 1 millimeters (mm) and 6 mm.

9. The instant-read thermometer of claim 1, further comprising:
one or more batteries configured to provide power to the instant-read thermometer.

10. The instant-read thermometer of claim 1, further comprising:
a capacitor configured to provide power to the instant-read thermometer.

11. A method comprising:
detecting, using one or more sensors associated with an instant-read thermometer, a range of temperatures when the instant-read thermometer is inserted into a food, wherein each temperature, of the range of temperatures, is associated with a different location of the one or more sensors within the food;
determining a lowest temperature of the range of temperatures; and
based on a determination of the lowest temperature of the range of temperatures, providing haptic feedback to a user.

12. The method of claim 11, wherein the determination of the lowest temperature further comprises tracking the range of temperatures on a graph.

13. The method of claim 11, wherein the determination of the lowest temperature is based on the range of temperatures beginning to increase after decreasing for a predetermined amount of time.

14. The method of claim 11, further comprising:
displaying a temperature of the food based on a location of the one or more sensors.

15. The method of claim 11, wherein the haptic feedback is generated using an actuator.

16. The method of claim 15, wherein the actuator comprises at least one of:
an eccentric rotating mass (ERM) actuator;
a linear resonant actuator (LRA);
a voice coils actuator (VCA); or
a piezoelectric actuator (PA).

17. The method of claim 11, wherein the one or more sensors comprise at least one of:
a negative temperature coefficient (NTC) thermistor;
a positive temperature coefficient (PTC) thermistor;
a resistance temperature detector (RTD); or
a thermocouple.

18. The method of claim 11, further comprising:
providing, based on the determination of the lowest temperature, an audible notification.

19. The method of claim 11, further comprising:
causing, based on the determination of the lowest temperature, an indication that the lowest temperature of the food has been detected to be displayed.

20. The method of claim 11, further comprising:
causing an indication to be displayed, wherein the indication provides a direction of which way the instant-read thermometer should be moved to obtain the lowest temperature.
